(19) United States
(12) Patent Application Publication
(10) Pub. No.: US 2004/0073446 A1
(43) Pub. Date: Apr. 15, 2004

(54) System and method for design and production of certificates

(76) Inventor: Bradford Lyle Snow, Meridian, ID (US)

Correspondence Address: Bradford L. Snow, 1298 N. Cliff Creek Place, Meridian, ID, 83642, US

(21) Appl. No.: 10/641,453

(22) Filed: Aug. 16, 2003

Related U.S. Application Data
(60) Provisional application No. 60/406,486, filed on Aug. 28, 2002.

(51) Int. Cl. G06F 17/60

(52) U.S. Cl. 705/1; 705/44

(57) ABSTRACT

A system and method joins an intended recipient of a certificate with a certifying organization to design a certificate document of greater display value. Computerized support and collection of a wide range of organizational, personal, and sentimental objects of value are used in the design of the certificate. A collaborative method, along with supportive communication, increases both motivation and knowledge of the intended recipient. The recipient is provided controlled freedom to create objects and dynamically personalize, customize, and modify the certificate display. Organizations using the system and method benefit from reduced counterfeiting of certificates, improved communication, and improved public relations.

### RELATED INVENTION

This application claims priority to and claims the benefit of U.S. application Ser. No. 60/406,486 filed on Aug. 28, 2002.

### FIELD OF INVENTION

This invention relates to the field of certificate design, presentment, and production for display purposes, more particularly to the computerized process, methods, and systems utilized to deliver an improved displayable certificate.

### DESCRIPTION OF PRIOR ART—BACKGROUND

The nature of certification has changed relatively little over time. Prior to printing presses, significant achievements allowing passage to higher orders for religious acolytes were acknowledged by high priests conferring handwritten certificates of sheepskin upon which seals of authenticity were embossed. While advances in publishing technology have been embraced in producing certificates, the display characteristics of today closely resemble age-old rites of passage and achievement. As a highly valued recognition of personal achievement by the recipient, display of the certificate is common. Regardless of organizational type, certificates are designed to convey the authority and import of the certifying organization and bestow an element of this import, recognition, or belonging to the recipient. However, in a mass produced and standardized environment, the value of the document has diminished from its more customized, hand crafted roots. Such documents include, but are not limited to, diplomas, marriage certificates, birth certificates, certificates of honor, and employee recognition certificates.

Even as mass produced, standardized documents, certificates are important icons of self worth and are often displayed. Displays serve varied purposes depending upon the individual. The display may be intended for viewing by a recipient, or for viewing by others. The academic certificate (diploma) provides a useful example for conveying some of these purposes. For example, a medical doctor typically displays a diploma in the exam room to build confidence in patients. Other diploma recipients display diplomas for their own viewing, as a reminder of fond memories of school years. Parents may display a child's diploma as a source of building pride in their offspring's accomplishments.

However, it is also common that improvements are made to improve the display attributes of the original certificate after presentment or conveyance by the certifying organization. For a doctor, an austere, simple, framed display with no other embellishments may convey a sense of tradition that reinforces the import and authority of the certifying organization and the confidence of the patient. For a secondary school graduate, additional display objects to the diploma certificate, such as photographs of school chums or school activities add to building memories of school days. To parents of the graduate, the addition of photos of their child increases the pride engendered by the display. Such diversity of display attributes expands with other certificates such as birth, marriage, etc.

In the art of certificate display, there are several improvements that have been invented in the patented art to provide for the desire to improve the display attributes of certificates. Most art is akin to scrapbook, photo, and other displayable two-dimensional visual objects. The known patented art is conveyed in: U.S. Pat. No. 6,119,386 to Henry (2000); U.S. Pat. No. 5,918,398 to Stanley et al. (1999); U.S. Pat. Des. Pat. No. 343,736 to Ng (1994); U.S. Pat. No. 5,005,869 to Smith (1991); U.S. Pat. No. 5,383,293 to Royal. The art is scant and offers only marginal improvements on traditional display techniques. U.S. Pat. No. 6,119,386 by Henry et al. (2000) provides a mat board layout where a plurality of secondary spaces are precut below the primary space (reserved for a primary certificate). The layout is intended to provide a display for those individuals who receive an initial certificate and must be re-certified over time. The spaces remain empty until re-certification takes place. While functional, the empty spaces seem to suggest a lack of achievement and defeat any object of pleasing visual display. U.S. Pat. No. 343,736 to Ng (1994) is a design patent for the display of a diploma in which a school seal is placed below, and the year of graduation is placed above, a fixed space and location for a diploma. The fixed display attributes typifies the nature of mass produced, standardized display. U.S. Pat. No. 5,005,869 to Smith (1991) provides a combination of transparent strings for multiple hardcopy certificates and display objects, to be paged together and allow each object to exist in a book form. The design of this display attempts to add a level of multi-dimensionality and is much like a scrapbook to convey the fixed display attributes prevalent in the art. U.S. Pat. No. 5,383,292 to Royal utilizes a transparent sheet to provide a base for a secondary image object to be placed over a primary document or viewable object. The purpose is to provide a multi-object view on a single plane. It is a variation of a collage using a transparent medium to allow more than one object to be seen at one time. U.S. Pat. No. 5,918,398 Stanley, et al. (1999) provides a specially cut mat board for one or more objects and a space for the designer to spell out a customized message or name utilizing a wide range of fonts and colors. The display and the associated characters are fixed in size, color, and font and remain bound by the hardcopy nature of the art.

While the art strives to create displays that are more flexible (multiple reserved spaces for re-certification, transparent strings for paging), customizable (letters to spell words), or more visually complex and interesting (transparent film for multiple images), the resulting displays are reliant on the traditional methods of production and distribution. The art is confined to embellishing a preexisting, traditional, non-customized, non-personalized hardcopy certificate. Within this environment, the only available tools for the display art are frames, mat board, and other existing apparatus. At the same time, recipients desire rich visual displays that are personal and customized to their desires. As the population increasingly becomes computer-savvy to the wide range of customization and graphic capabilities of a computerized world, the desire for improved displays continues to grow.

In overview, the tradition-bound process and art of certificate design, presentment, and display in its present form suffers from the following deficiencies and inefficiencies:

Reliance on physical hardcopy objects forcing recipients to search for hardcopy objects of display after presentment. As time passes these objects deteriorate, fade, or generally become harder to locate.

The delay in time from presentment to display, in conjunction with the reliance on hardcopy, results in unavailability of display objects. For example, many baby or school photographers destroy photographs closely after the photo is offered for sale. Since recent recipients, such as graduates or new mothers are preoccupied after the certification event, they often defer display creation to a time when such objects have been destroyed.

Incompatibility with existing systems: the majority of elements surrounding object creation (such as the certificate itself, and display objects such as digital photographs, logos, mascots, etc.) originate and are stored in computers; yet the production process remains focused on hardcopy documents. Presentment after the fact reinforces inaccessibility since the recipient is no longer involved with the certifying organization. Thus the present design system is unnecessarily divorced from the systems that contain display object sources.

By focusing on a decentralized display-creation process the existing art results in the production of a single display. Multiple and varied versions are difficult to create. Yet, the inherent value of the certificate leads to a desire to create personalized versions to share with others. For example, a student may want a different version for display for parents, customized with photographs and a personalized text message offering thanks for their support.

The design systems of the prior art are tied to the size of the display to the hardcopy certificate and subsequent objects. Resizing certificates or objects of display is difficult. Background colors are confined to mat boards that are difficult to replace and require manual cutting to fit the certificate. Fonts for text are fixed in type, size, and color and are difficult to change.

By not having a centralized and coordinated system to support cooperation of those who create certificates and those who create display objects, display producers must rely upon photocopying objects without proper copyright approval.

The prior art tends to tie the display to a single certificate; however, in many cases, re-certification or additional certificates of education (High School, Bachelors, Masters) or birth are desired on a single display. Such a display should not have empty spaces suggesting lack of achievement, nor assume fixed sizing requirements before hand.

Overall inefficiencies of hardcopy access, delays in design process, and lack of computer-aided design in sizing, placing, or otherwise creating and manipulating electronically equivalent objects creates displays that are not up to par with the expectations of high quality display objects.

The cumbersome nature of creating such displays in a computer-savvy population reduces the desire to create meaningful or motivating displays. This tends to reduce the motivational value of the certificate icon.

The traditional method of certificate production and display is susceptible to counterfeit since these display characteristics are standardized and generic and consequently easy to copy.

By deferring any access to the certificate prior to presentment (and subsequent to the recipient's involvement with the organization), the majority of the educational and motivational value associated with leveraging the power of anticipation is abandoned.

### Objects and Advantages

Accordingly, a new approach is provided to overcome the above deficiencies and by which a more effective and efficient method is available through a new system and methods that transcend the issues inherent in the present art. These objects and advantages are:

To provide a system and method for certificates and display objects to exist in a centralized location in equivalent viewable, electronic-object form prior to presentment.

To provide a system and method for new display objects to be created and catalogued into the centralized location together with certificates and existing display objects

To provide a system and method for intended recipients (users) to manipulate said objects in size, location, color and other display attributes into a display format.

To provide a system and method for certifying organizations to effect controls upon the user to ensure certificate validity and display attributes are consistent with the certifying organization desires.

To provide a method and process whereby display objects are made available to users via a computer screen for creating, accessing, viewing, and manipulating in design creation and production activities.

To provide a new process for further motivation and education of the intended recipient by conveying messages onto said computer screen during design and production activities.

To provide a system and method whereby viewable access to a certificate by an intended recipient creates an enhanced desire to take possession of the certificate, thus increasing motivation to exhibit desired behavior leading to certification.

To provide a system and method whereby multiple versions of a final display document can efficiently and easily be created.

To provide a system and method whereby the final display document can be stored, transmitted, viewed, and printed by others in electronic form.

To provide a system and method whereby computer-controllable objects such as video streams and audio messages can be included in an electronically enhanced final display document.

To provide a system and method whereby personalized objects such as photographs, fingerprints, or other difficult-to-recreate objects are included on the certificate itself, or the final display document, thus reducing potential for counterfeiting.

Further objects and advantages are to provide a repository of past design efforts to allow a user to update a final display document should new objects become extant (such as an additional diploma for an advanced degree, or birth certificate for an additional child). The new method and system is a significant and primary improvement of the existing art through unique application of computerized methods. From the perspective of the certifying organization this will require adoption of new methods. However, the new system can leverage existing, underutilized systems and sources. Adoption of the new system and methods do not preclude retaining the traditional method and process for certificate production, and a certifying authority may wish to utilize both old and new. The following description and associated drawings will support the exposition of yet further objects and advantages.

### SUMMARY OF THE INVENTION

A method and system is disclosed to provide the means by which the organization can support the user in the display design process prior to certificate presentment. This provides significant benefits to the organization and recipients in efficiencies, education, motivation, counterfeit reduction, and increased post presentment relations such as alumni giving. Additional benefits will become apparent in the description, discussion and disclosure below.

### Centralized Computer System for Certificate Design, Presentment, and Production for Display

An embodiment of the present invention provides a computerized system and methods to join the processes of certificate design and production for display. The resulting final display document of the new method and system is produced in either electronic or hardcopy form. The system utilizes a computer readable certificate object, transformed to coexist with other computer readable objects. Through the use of a centralized system and processes, a wide range of objects (design objects) of value from many sources can be created and made available for design application. The system utilizes design application software which reads the available objects and allows a user to easily manipulate, combine, and control the presentation characteristics such as size, position, background color, and other display techniques and controls to affect the design-characteristics of the display as they evolve in the computer arts. Additional aspects of the system are disclosed in the detailed discussion below.

### Object Input and Object Library

All relevant design objects are located in the object library. All objects are formatted for access by the application and production software system, and a set of identifiers are associated with each object to enable control and access. The object library configuration and object access disclosed herein represent but one of many such configurations. The certifying organization maintains control and determines the extent of object access and design freedom afforded to the user. In creating design objects, any electronic image creation means (e.g. object creation software, digital camera, digital scanner, microphone, etc.) may be employed. An example of the wide range of objects, but not to limit the range of the invention, would include digital photographs, animation, video recordings, newspaper articles, sound recordings, statistical charts of achievement, or otherwise any related object of personal, personalized, or sentimental value.

### Application Software

The computer environment available to the user to participate in utilizing the objects in the design effort is driven by typical graphical user interface presently available in the computer science art. The software is typically known as page layout software, or digital media design software, or design application software (the preferred term, used hereinafter). Such software has evolved for use on standalone personal computers as well as in high volume networked client-server systems. Client-server systems can utilize a process known as Offline Pre-press Interface (OPI). The process substitutes high-resolution objects with low-resolution objects. The low-resolution objects are distributed to the client workstations for design to occur and the high-resolution object remains on the server. This minimizes file transfer time. The OPI process creates a set of computer readable comments on the workstation describing edit actions on the object during page layout, including location, size, cropping, rotation, brightness. Upon completion, these comments are transmitted from the local workstation to the central server where the high-resolution object is located. Placement occurs through application of the comments to the high-resolution object. In the present invention, novel application of design controls are used in improving the art of certificate design, presentment, and production for display. Software capabilities of available graphics computer programs are typically configured to allow the maximum freedom to the user. The invention herein controls the level of design freedom through the unique application of controls upon user design actions. The design application software in one embodiment conveys the design palette display and design object controls along with options disclosed herein. Required capabilities of design application software include the ability to generate such control code along with object manipulation capabilities suitable for users who are not experts in graphics design. Additional elements of the design validation process, utilizing the control codes of design application software, ensure that valid designs occur.

### User Interface

A design/display screen provides the user with a design palette. The design palette is segmented into restricted and user-accessible areas. The screen provides an interface with the design application software and the basis for the user to manipulate the display objects. In the present embodiment, controls are applied by the certifying organization to define the range of object manipulation and placement afforded to the user. The interface also provides the means for conveying educational and motivational messages to the user.

### Educational and Motivational Aspects

The system provides the basis for design activities to occur well before the certification and traditional presentment event. Thus the user is allowed sufficient time to produce alternative objects and consider alternative layouts. This design period provides an opportunity for the certifying authority to leverage the user's personal attachment and ownership of a customized, personalized display. A centralized system as disclosed herein allows an interface to a certifying authority's computer systems which hold measures of the user's performance toward achieving certification. By showing the user such performance measures, it can guide and motivate the user toward desired behaviors. For example, in an academic environment, examples of messages could include interim academic performance, statistics on earnings power of graduates, and general graduation requirements or other school-related information can be displayed. Such a graphical personalized system herein provides relevancy to computerized education efforts. (Pew Survey).

The learning and motivational aspects of the system and methods are applicable to virtually all certification environments, not just academic. However, in the academic environment in particular, the close relationship of personal effort to certification presentment provides an ideal environment to leverage the cause-effect relationship. Specifically, by leveraging the certificate with personal objects, with a great deal of individual effort provides obvious additional motivation to associate efforts of study to achieve receipt of the final display document. Another advantage of the invention is that it allows ease of joint design wherein the user can share the design effort with others such as parents. Such joint activity supports building additional internal commitment to desired behavior through creating joint expectations for achievement. In all cases, the user has the opportunity to learn new software skills associated with, as well as the benefits of enhanced value from, an improved display and process.

### Output

Through the methods and systems herein, a final presentation display output can be created as either hardcopy or as an electronic presentation as determined by the certifying organization. By virtue of creating an electronic version of the final display object, the memories of the event can be shared much more efficiently with others; for example, the display object could be transmitted to others over the internet for viewing. Detailed descriptions of the system, methods, processes and various features of the present invention are disclosed in the following detailed disclosure.

### Benefits to Certifying and Affiliated Organizations

A centralized computer system that ties together previously disparate systems provides significant benefits to both recipients and organizations. From an organizational standpoint, in many cases, there are multiple organizations involved in a given certification process which could stand to better meet their mission through the systems, methods, process, and concepts presented herein. For example, the organizations involved in a birth and subsequent certification process include hospitals, doctors, departments of vital statistics, and departments of child welfare. Each of these organizations has an inherent interest in the welfare of expectant mothers and children, and has information to be shared which could improve the mother and baby's condition. Personal involvement in creating a display provides a unique communication channel for reinforcing important neonatal and infant welfare information.

Other benefits to certifying organizations include improved validity of the certificate itself through the act of attaching personal identifier objects to the final display document, such as photographs of the recipient. Printing such objects onto holographic medium further reinforces the validity. Such objects and methods reduce the ability to counterfeit the certificate. In addition, by virtue of creating an electronic version of the final display object, the memories of the event can be shared much more efficiently with others; for example, the display object could be transmitted to others over the internet for viewing. The system and methods thus tend to improve the recipient's relationship and opinion of the organization.

### BRIEF DESCRIPTION OF THE DRAWINGS

In the drawings:

FIG. 1, is a diagram illustrating an overview of an embodiment of a centralized computer system for educational and motivational messaging, certificate design, and production.

FIG. 2 is one embodiment of the system in FIG. 1 showing the detailed methods and processes of object creation, approval, and cataloging.

FIG. 2a is an expanded example of the object cataloging schema for the systems of FIG. 2.

FIG. 3 shows a process for the system of FIG. 1 illustrating the detailed methods for object access, display design, and design validation prior to production.

FIG. 4 shows a process for the systems of FIG. 1 showing the detailed post-design and production process.

FIG. 5 is a diagram illustrating an embodiment of a centralized computer utilizing a database for serving multiple certifying organizations and users.

FIG. 6 is an embodiment of the design/display screen of the user interface.

FIG. 7 provides a design layout using various graphic formats of the stored display objects as developed in FIG. 2a.

FIG. 7a is one representation of a design palette provided as an example in an academic environment wherein the design palette has objects of FIG. 2a located in restricted areas of the palette.

FIG. 7b is an example of a final display document in an academic environment with additional representative design objects.

FIG. 7c is an example of an electronic version of a final display document within an academic environment with representative image objects as developed in 2a in addition to alternative objects.

FIG. 7d is an example of a final display document in an academic environment in which personalized objects serve to diminish counterfeiting potential.

FIG. 8 is a drawing of a personalized certification in trophy form with electronic means.

FIG. 8a is a drawing of a three-dimensional coordinate system.

### SPECIFICATION

The approaches described herein are provided to facilitate understanding, but are not intended to constrain alternate approaches or otherwise limit the scope of the invention. It is to be expressly understood that the illustrated embodiments are set forth as examples and not by way of limitations on the invention. It is well known in the computer sciences that methods and techniques used in operating systems and software change rapidly. The approaches provided in the examples are intended for one practiced in the art to implement in the context of such a changing environment. The illustrative nature of the description is thus intended to provide clarification to those practiced in the art, but not as a restriction on the scope of the invention.

In the figures, elements that share attributes or represent alternatives are designated with the same numeric identifiers.

The terms “user” and “intended recipient” are considered equivalents and are used variably to provide clarity within the context of the exposition. However, note that the intended recipient is not necessarily equivalent to the individual whose name appears on a certificate. An example in this context would be a birth certificate, in which case, the newborn's name appears on the certificate, however, the newborn's parents for example, would be a user.

The terms, “organization”, “certifying organization”, and “authorizing organization” indicate an organization authorized to undertake certification, authorize certification, or provide substantial support toward qualifying an intended recipient to become certified. The use of these terms is useful in describing the system and methods due to the fact that one organization may provide certification of a given individual and yet a different organization may actually provide the authorization for the same individual to be certified. For example, a bureau of vital statistics may provide certification of a newborn, but a hospital may authorize such certification. In addition, a recipient may or may not be a member of a certifying or authorizing organization (e.g. a student is a member, a newborn is not). Thus, the term “certifying organization”, “authorizing organization”, and “organization” should be considered as equivalents in the context of this discussion. In addition, within the context of system and methods herein, the term organization may also include a suitable outside source as an agent of the certifying or authorizing organization.

The general term “object” as used herein includes any image, sound, or perceptual representation that enhances the viewing, listening, or other sensory pleasure available from the final display document. Such objects include digitally stored computer files of images and sounds, including photographs, text, animation, music, colors used in display, borders, and/or control objects for viewer use. The broad range of such objects, made available through decisions by the certifying organization, some requiring input by the intended recipient for use in design efforts of the final display document, is an important element of improvement over the existing art. As new objects become available through the computer arts, the present invention is not constrained in embracing them.

Various terms distinguishing the objects utilized in the description exist for purposes of user design and certifying organization control. The term “object” has many meanings as it relates to use in computer aided systems. In the art of certificate display, the term is particularly vague due to the reliance on tradition. Therefore, a summary description of each type of object discussed herein is provided for reference and to aid in understanding the discussion of the drawings and the present embodiment.

Design Objects: digital files of images or sounds or other objects created by the user or a third party and those objects by the certifying organization on behalf of the user. These are objects used for design efforts associated with the design palette.

Restricted Objects: digital files of images or sounds created by the certifying organization (or third party on behalf of the organization) which are associated with prohibiting any changes to the design attributes such as the object's position on the palette. Typically the certificate would be a restricted object. Since the system and methods allow for a wide range latitude for the organization to control a user's design actions, the term restricted objects and the methods applied to such objects might vary by organization.

Placeholder Objects: digital files of images or sounds created by users or third parties, or certifying organizations to serve as surrogates to allow display design efforts to take place while objects are still being created, or are deferred to production. A placeholder object serves to provide a “working” object to allow design to occur free of object availability. A facsimile representation of a diploma is one example, as is a surrogate photograph representation of a photograph that does not yet exist. Placeholder Objects are intended to be updated by Replacement Objects (see next definition).

Replacement Objects: digital files of images or sounds or other objects created by users or third parties, or certifying organizations to replace Placeholder Objects: e.g. a final diploma certificate object, or a finalized photograph. In the present embodiment, replacement of both placeholder and restricted objects can occur in the same manner. The use of Placeholder and Replacement objects are used extensively in the Open Pre-Press Interface (OPI) process known to those in the computer/desktop publishing arts. Use of OPI techniques provides useful functionality as will be detailed below, but does not preclude a Placeholder Object from being a high-resolution object in the present embodiment. Replacement Objects can be placed on all areas of the design palette as dictated by the controls applied by the certifying organization.

Control Objects: a digital representation for an electronically viewable version of a final display document. A control object allows the viewer of the display document to invoke a set of imbedded commands which will effect the occurrence of actions upon other design objects. For example, in the event a user placed an animated video object (design object) onto the user palette, the user would also want to include a playback Control Object to allow a viewer to play, stop, or otherwise control the playback of the video.

Message Objects: text, charts, graphs or other objects, separate or in combination that are conveyed to the user while engaged with the design system. In one embodiment the objects are conveyed to the user upon the design/display screen located in close proximity to the design palette, but are in a reserved location of the user's design/display screen. Other embodiments can include separate screens within the design/display screen for messaging.

### A. Centralized System Overview

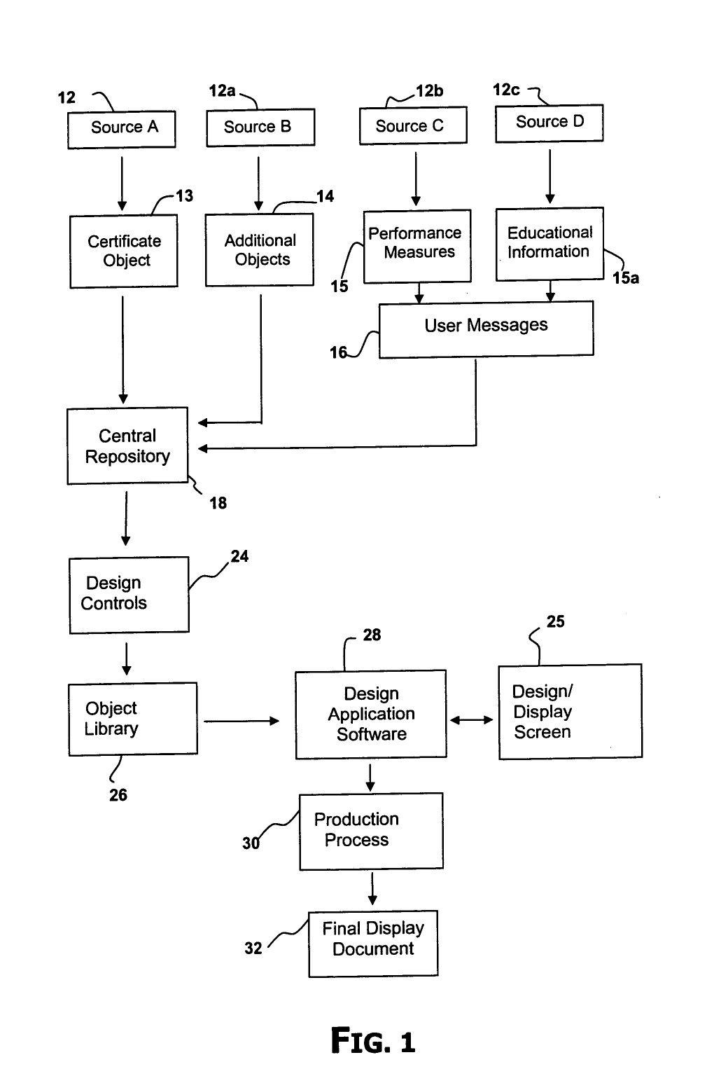

Referring now to the drawings, FIG. 1 shows a source 12 (Source A) supplying a certificate object 13 to a central repository 18 which is a centralized collection of digital objects. A different source 12a (Source B) provides additional objects 14 to central repository 18. Each object of central repository 18 is associated with design controls 24, to create an object library 26. Objects and controls are thus made available to design application software 28, whereby a design/display screen 25 facilitates user interaction with said objects in creating a display for a production process 30, creating a final display document 32.

User messages 16 also supply central repository 18, however, they are only intended for user viewing in design/display screen 25, but are not applied in creating the final display document 32. User messages 16 are created from performance measures 15 and educational information 15a. Performance measures 15 in the present embodiment come from yet another source 12b (Source C), and the source for educational information 15a is a different source 12c (Source D). User messages 16 are compatible with, and are supplied to, design application software 28. User messages 16 could be conveyed in text, charts, animated video, audio, or other objects to best deliver the desired effect. User messages 16 could also be conveyed to the user through alternate means such as through a parallel centralized repository.

FIG. 1 underscores the fact that sources of objects and data for the system come from disparate sources (12, 12a, 12b, 12c), however, the present invention is not limited by the four sources shown. The four sources shown supplying central repository 18 can be any number of sources approved by the appropriate certifying organization. Example sources include the certifying organization, affiliated or independent or state organizations, the user, third party vendors, or agents of those in this group. The number and nature of sources depends upon the number and nature of organizations involved in the certification process. For example, a birth certificate is an example where certificate object 13 can come from one organization (vital statistics) and performance measures 15 can come from another organization (hospital). It is the purpose of the centralized system to coordinate these disparate sources in order to leverage the various objects represented in central repository 18.

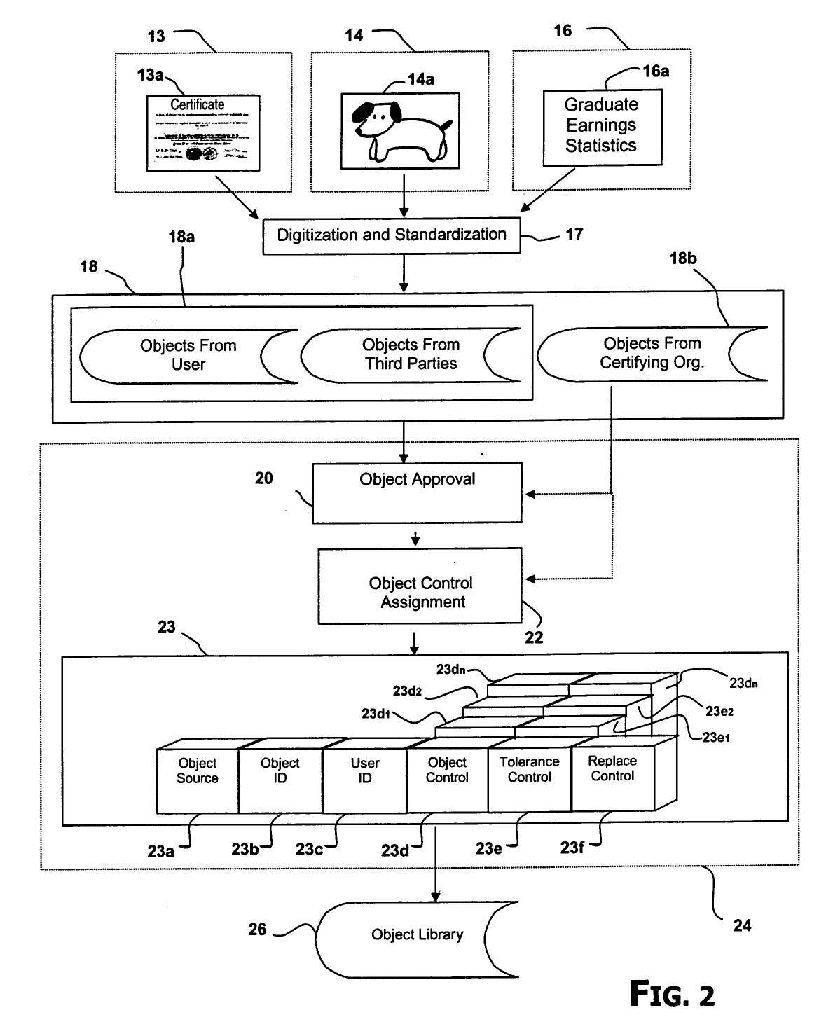

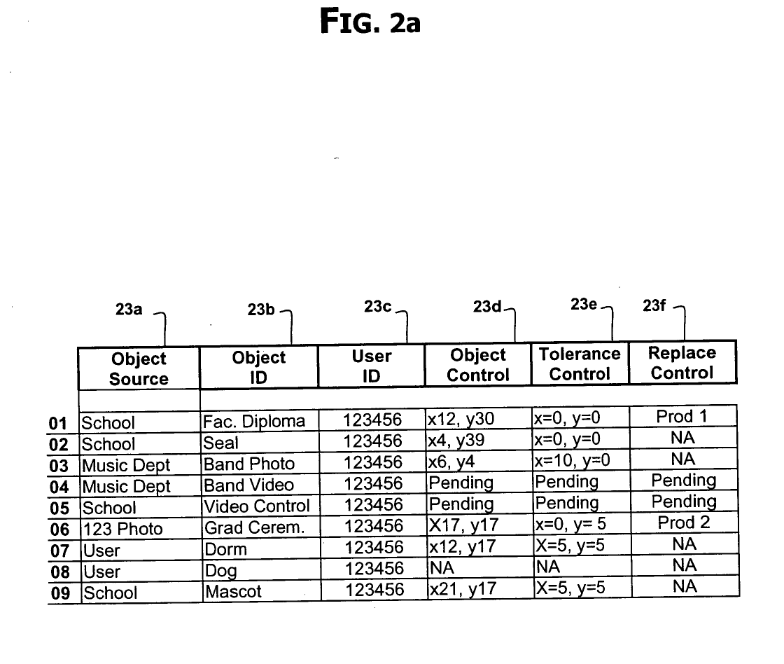

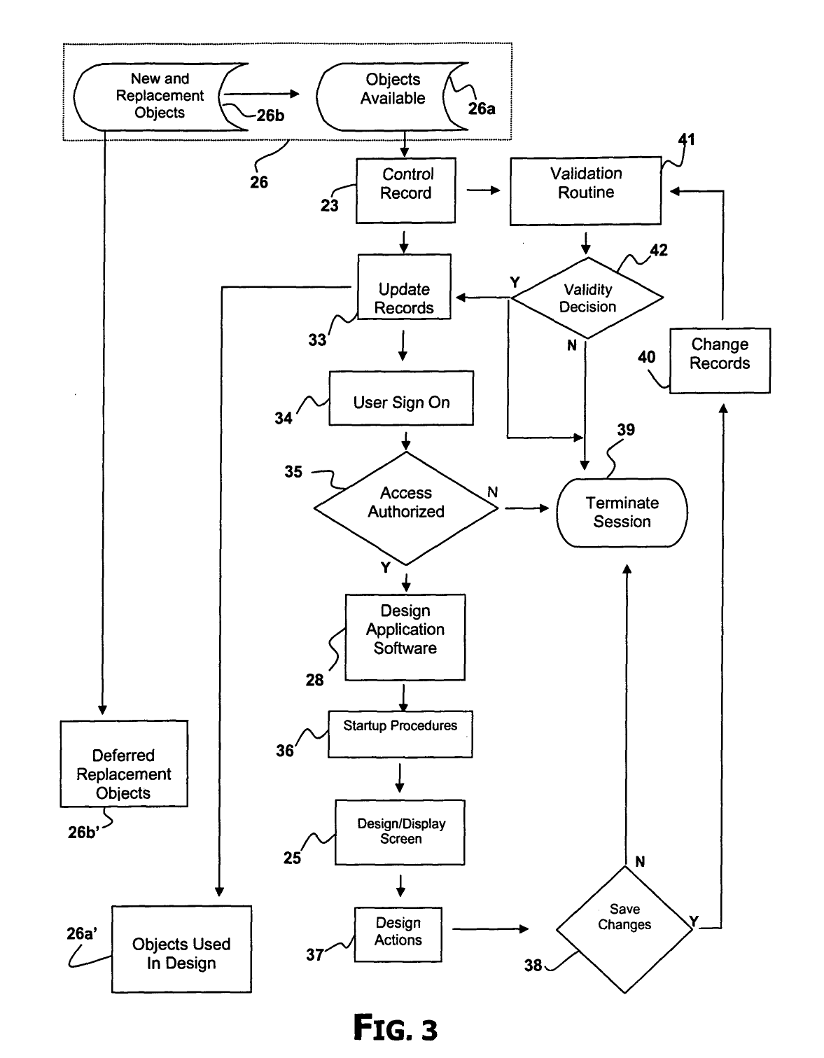

FIG. 1 indicates further processing of objects in central repository 18 through application of design controls 24. Design controls 24 are key to successful organizational control in a centralized environment in which many sources provide objects and many intended recipients use objects in design. Design controls 24 include object suitability evaluation and a cataloging process. The cataloging process results in the creation of identifiers and indicia to provide organizationally determined controls. The controls provide a baseline design and thus serve as the basis for automatically evaluating changes to the design by the user. The controls also define the restricted and user areas of the design palette. The details of design controls 24 in relation to object creation, approval and cataloging are presented in FIG. 2. The details of user object access in design efforts, and design evaluation and validation are shown in FIG. 3

### B. Object Creation, Approval, and Cataloging

FIG. 2 represents an embodiment for the system and methods of FIG. 1 in which objects, including certificate object 13, additional objects 14, and user messages 16 are introduced into central repository 18 for further processing. In the embodiment in FIG. 2, an example hardcopy certificate object 13a, a digital photograph 14a, and a text object of educational information on graduate earnings statistics 16a are introduced. These are examples only and are used to present, but not limit, the teachings of the present invention. A digitization and standardization process 17 is applied to create objects for central repository 18. Any number of conventional processes are available. Central repository 18 is a conventional database and serves as the basis for design controls 24 to be developed. Central repository 18 is further segmented between the group of objects from the user(s) and third parties 18a, and the objects from certifying organization 18b.

Hardcopy certificate object 13a, digital photograph 14a, and a text object of educational information on graduate earnings statistics 16a are representative of a wide range of objects that are introduced into central repository 18 in variable original form, either hardcopy or electronic. In the process of digitization and standardization 17, objects are converted through various conventional means such as through a digital scanner connected to a computer to create a digital image of a hardcopy object. Digitization and standardization 17 creates a compatible computer-readable collection of all objects in central repository 18. In practice, many devices are capable of creating digitized objects including digital cameras, microphones, pre-existing digitized objects from a computer, etc. Additional activities represented in digitization and standardization 17 include virus-checking, standardizing formats, and otherwise ensuring suitability for access by design application software 28 (FIG. 1). Digitization and standardization 17 would typically involve the use of various computer software packages including virus checking and image processing software known to those practiced in the computer arts. In the present embodiment, all such objects would be restricted to read-only status once entered into central repository 18.

Once objects in central repository 18 are thus prepared, design controls 24 are established. Design controls 24 represent a process whereby the authorizing organization makes decisions regarding user access and interaction with objects within central repository 18 and applies such decisions to ensure control. As part of design controls 24, object approval process 20 is conducted by the certifying organization to make decisions regarding object-content suitability for the design process. In the present embodiment, object approval process 20 would include an evaluation of object-content suitability and assurance of copyright compliance. The process is one of culling out inappropriate objects or otherwise authorizing use in the system. Object approval process 20, under the techniques herein, could, for example, be the school, university, employer, organization, parent, etc. or a combination thereof.

Object control assignment 22 represents a cataloging and assignment process that results in a classification schema including, but not limited to, creating indicia (fields is the preferred term hereinafter) 23a, 23b, 23c, 23d, 23e, and 23f comprising control record 23. The actual number and nature of the fields in control record 23 must be considered and developed by the certifying organization as part of the overall deliberation and decision process associated with design controls 24. Note that the term “control record 23” conveys a single record (used for clarity in the present discussion) later on in the discussion use of the term “control records 23” is used. The terms are to be considered equivalent. The schema inherent in control record 23 is created by the certifying organization in applying design parameters (controls) to provide an organizationally acceptable baseline design and subsequent control over design-freedom limits of the user. Object control assignment 22 results in the creation for each approved object a computer-readable control record 23 for conveying the nature and scope of the controls applied. Thus, for each object residing in object library 26, a control record 23 would exist to sufficiently identify the object, the user, design attributes of the objects (control values), the degree to which the object attributes could be changed by the user (tolerance values), and production codes.

Objects are associated with the control comments via Object ID 23b field which holds the object file name. Note that by default a name is created during digitization and standardization 17 (in order to save the object to a disk). However, the process of systematically renaming objects after a full catalogue of objects (represented by object library 26) is created can provide a structure for better object management. For example, FIG. 3 shows an embodiment in which object library 26 is segmented. Structured file naming conventions would aid in managing such segmentation. Note that objects from certifying organization 18b may bypass object approval process 20. However, in this embodiment, in order to be compatible with further processing, all objects would require object control assignment 22. Many conventional page layout software packages can support the development of such computer readable codes.

The nature of the system and method of the present invention herein affords the certifying organization (or suitable outside source) a great deal of flexibility to establish the specific levels of control. Design controls 24 include approval of objects in the creation process as well as degree of object access and degree of allowable user-initiated change to an object attribute in the design effort. The controls created in design controls 24 provide an initial template for design as well as a basis for object design-change control when the user engages the design activities (FIG. 3). Object approval process 20 and object control assignment 22 will vary by specific requirements of a given certifying organization. To varying degrees the organizations will be concerned that the outcome conveys an acceptable organizational image. The degree of this concern will tend to determine the level of control applied in setting limits upon the user's efforts in creating the final display document 32 (FIG.1).

The primary attributes of a final display document are object content and object location and movement (i.e. layout) on the design palette. Object content is thus the primary consideration in object approval process 20. Object placement on the design palette is a primary consideration in object control assignment 22. Associated location considerations might include a determination of whether the user would be allowed to re-size, rotate, crop (create a subset of the original image), etc. an object from its initially approved location. Such location-oriented control decisions result in establishing x,y coordinate-related control fields for control record 23. Use of x,y coordinates that are readable by conventional graphic layout software are known to those in the computer graphics arts.

Referring again to FIG. 2, in this example, control record 23 is comprised of identifiers and controls (fields) to effect control on the various objects. In the figure these identifiers are preferably comprised of primary fields 23a, 23b, 23c, 23d, 23e, and 23f. Additional instances of fields associated with the same object (e.g. in the present embodiment, additional fields 23d₁, 23d₂, 23dₙ and fields 23e₁, 23e₂, 23eₙ) are shown to represent a variable number of instances of field 23d and 23e. Note that any such field of control record 23, particularly those that control a given object (i.e. in the present embodiment fields 23d, 23e, and 23f), are not constrained to the number of instances within control record 23. Thus, there is no intent to constrain the scope of controls that a certifying organization might employ. The method presented herein provides a useful manner in which to illustrate how such identifiers are used in the overall control-schema creation process of design controls 24. The resulting control record 23 could include field controls for attributes previously discussed such as size, cropping, rotation, colors, etc.

The primary fields of control record 23 are thus described herein as: Object Source 23a, to identify the creator or owner of the object. Object ID 23b, to uniquely identify the type and nature of the object. The specific requirements of identification would be dependent upon the computer operating system; however, it is typical to use a specific object name to uniquely name the object (e.g. “diploma”) and a suffix to identify the type of object it is: e.g. “.tiff”. (Note that such identifiers are omitted in the table for clarity in discussion.) User ID 23c, identifies the approved user. Object Control 23d, in this embodiment, identifies specific x,y values representing locatable coordinates on the design palette for providing a baseline location value. Additional fields 23d₁, 23d₂, 23dₙ, in the present embodiment, show allowance for additional control of object attributes should they be required by the certifying organization. Tolerance Control 23e controls are associated with Object Control 23d attributes and are used, in this embodiment, for limiting x,y movement of an object by a user. Additional fields, 23e₁, 23e₂, 23eₙ, allow for additional Tolerance Control 23e controls should they be required to control user actions upon objects. Replace Control 23f, controls the dependency between placeholder and replacement objects, in this embodiment, in the design and production cycles. While additional fields for replace control 23f are not shown in FIG. 2, additional fields (e.g. 23f₁₋ₙ), could be added for additional production control as needed in the same fashion as additional fields are available for Object Control 23d and Tolerance Control 23e.

Once approved objects from central repository 18 are so processed through design controls 24, they are stored electronically into object library 26. As new approved objects from central repository 18 (e.g. replacement objects) become available, object library 26 is updated. Thus, an initial acceptable (baseline) layout, allowable user-design freedom, and replacement and production interface instructions are developed.

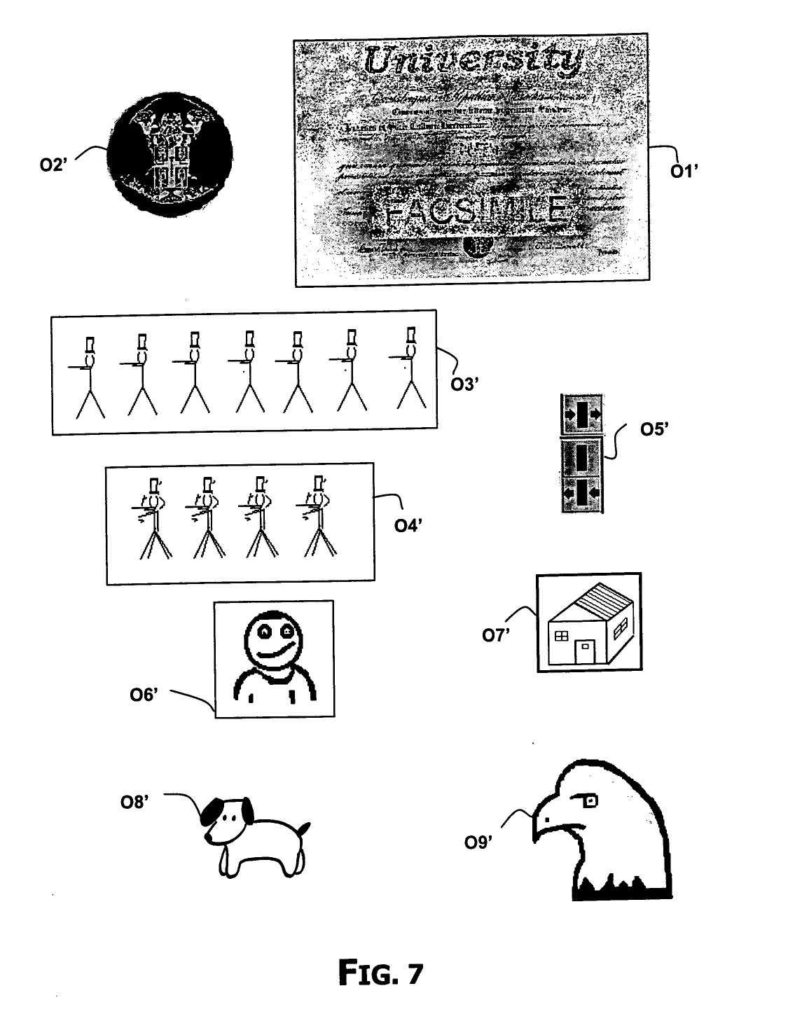

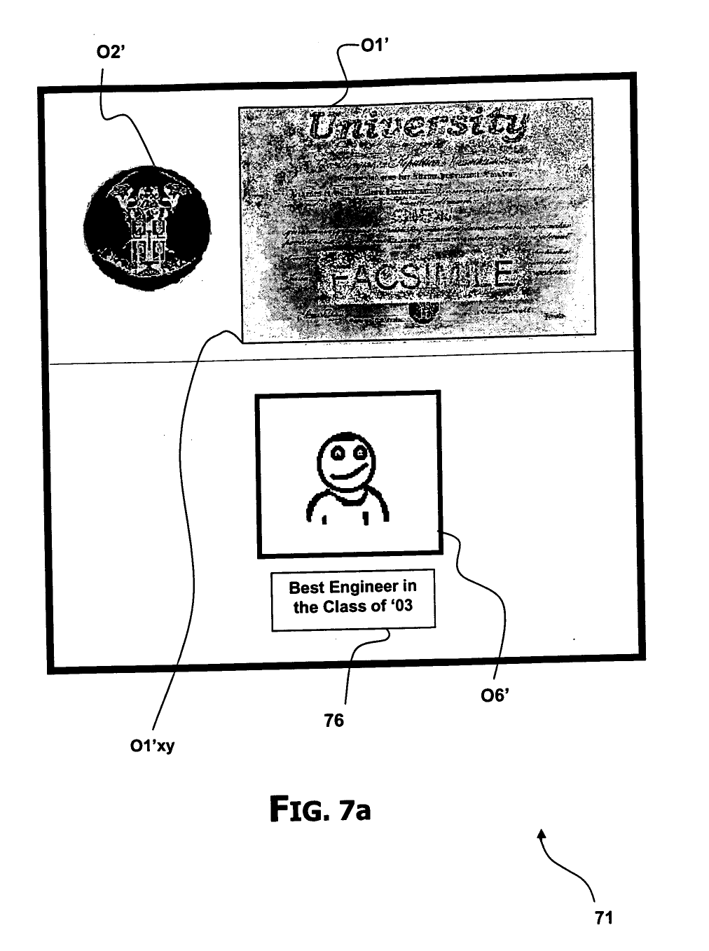

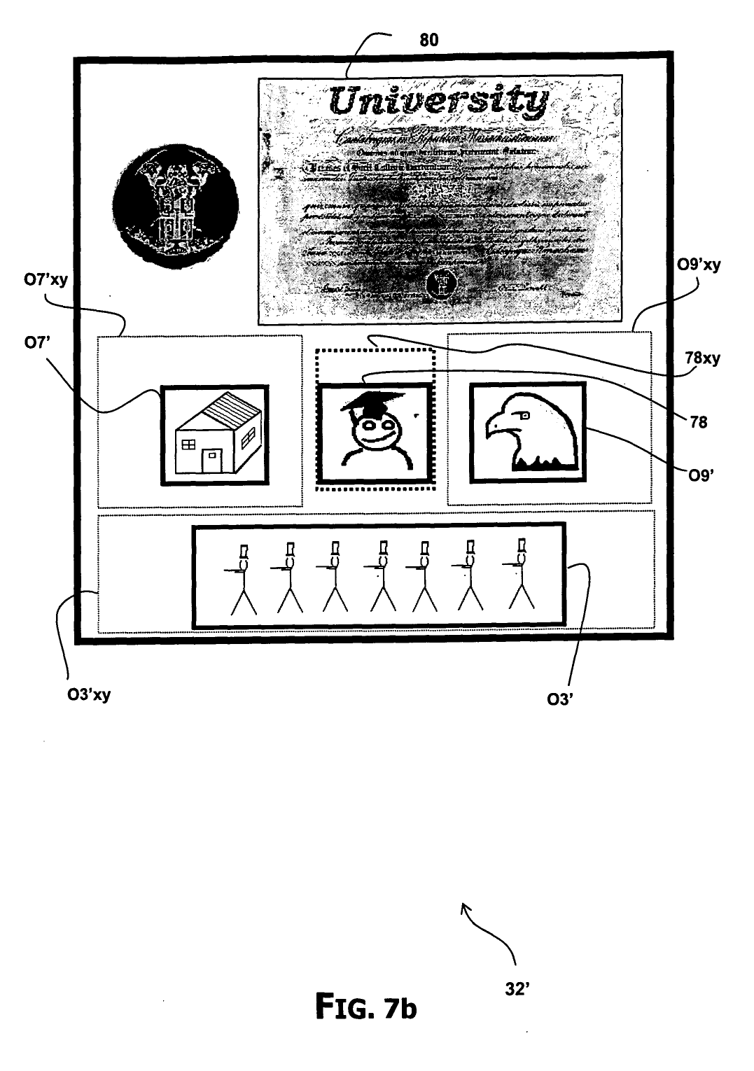

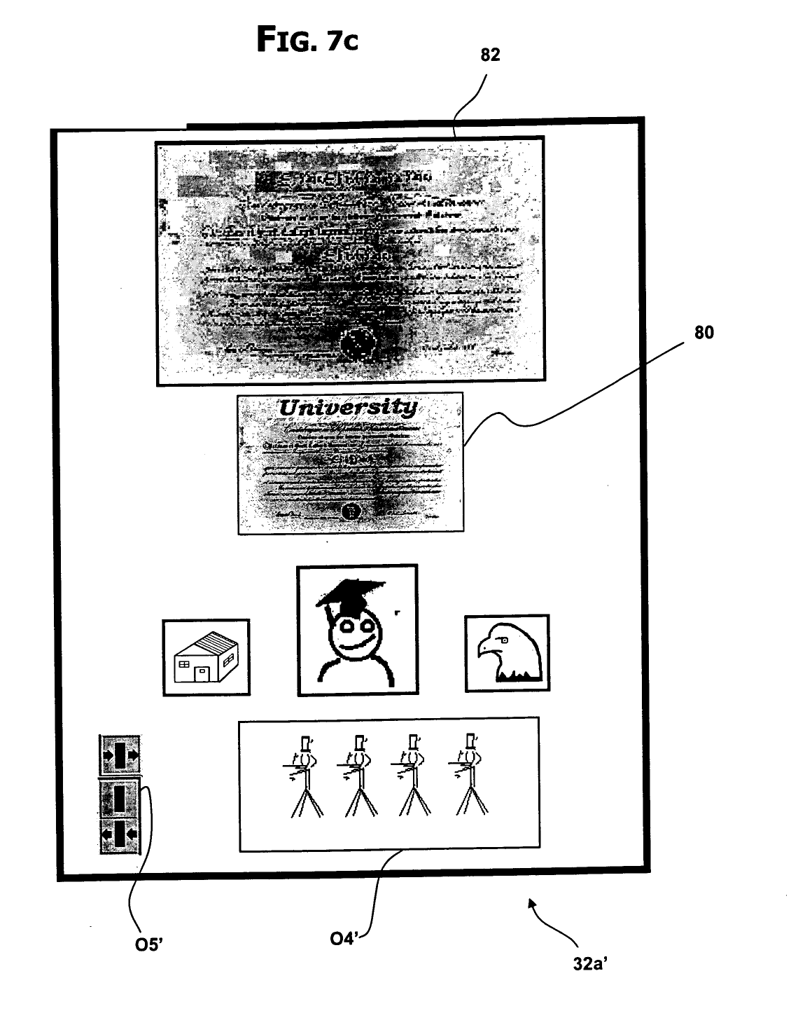

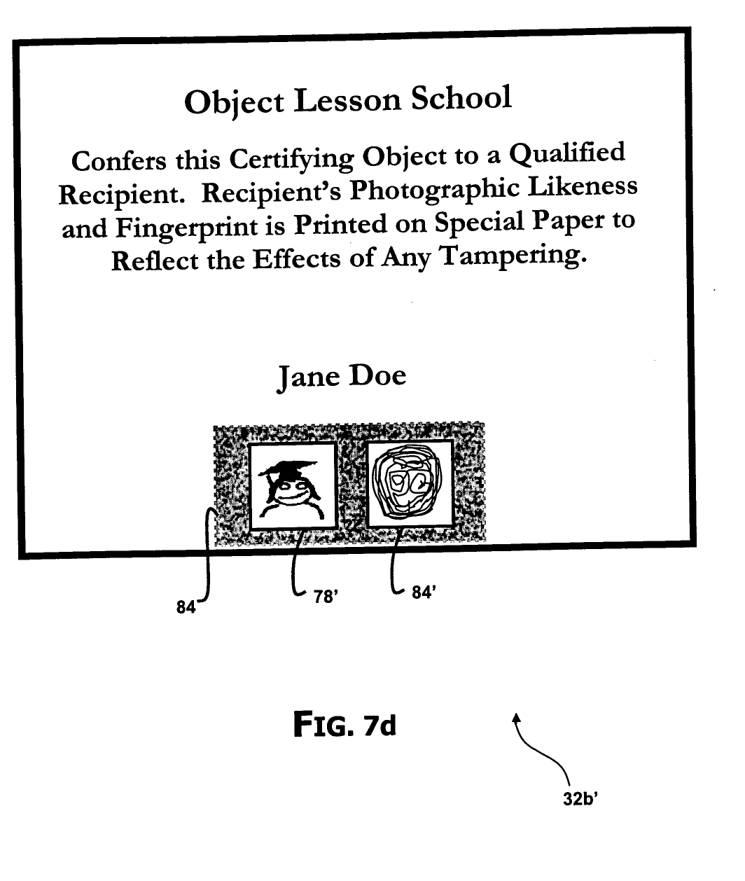

Referring to the example in FIG. 2a, the figure expands the discussion of control fields 23a to 23f of FIG. 2. FIG. 2a shows a number of rows identified O1, O2 O3, O4, O5, O6, O7, O8, and O9. Each row represents an individual control record 23 for each object, the control record 23 is comprised of control fields (columns) 23a, 23b, 23c, 23d, 23e, 23f as previously discussed. Each complete row thus represents a computer record for computer reading and processing. FIG. 2a provides examples of objects as they might be created in an academic environment, and the term “school” is used to convey the certifying organization. These examples are used to illustrate and teach but are not meant to limit alternate objects or control fields. These specific examples provide a better understanding of object library 26 (FIG. 1, FIG. 2, and FIG. 3) cataloging, control and subsequent use of the objects in the system herein. This discussion will facilitate understanding of the objects when they are portrayed graphically later in the discussion (FIGS. 7, 7a, 7b, 7c, 7d). Indeed, reference to the graphic representation of objects in FIG. 7 may aid in the discussion of the objects below.

Note that the following example is based on objects to be made available to the design palette for a single user as identified in each row (Oₙ) in User ID 23c. The information in this field, while necessary for proper system operation does not aid in the present discussion and is thus excluded in the discussion below. It is to be understood that FIG. 2a is an example illustrating the operation of the method and system of the present invention. The columns 23a-23f can be any number for any object and the rows O1-O9 can by any number for any control record 23.

Row O1: Object Source 23a identifies the source of the object as a school supplied object. Object ID 23b identifies via descriptive nomenclature the object as a facsimile of a final diploma object. Object Control 23d value (x12, y30) provides the baseline location for placement of the object onto the design palette. Tolerance Control 23e value (x=0, y=0) indicates that the object may not move from the baseline location. Note how this method defines the restricted areas of the design palette. As discussed earlier, the x,y designators provide the basis for initial placement and further assessment (via Tolerance Control 23e) of acceptable user changes in design Note also that the single x,y value in controlling objects is a simplistic representation of the actual requirements. Four sets of x,y coordinates are needed to locate objects in a two-dimensional grid (i.e. x,y values for each of lower left, upper left, upper right, and lower right). Requirements for use of x,y coordinates to place objects are known to those in the computer graphics arts. In the present example, a single x,y value conveys the essence of the invention in applying control to placement. Note that use of such use of x,y coordinates can also be used to control orientation, cropping, and other locating-aspects for objects, and such use is not precluded in the scope of the invention. As mentioned earlier, Object Control 23d x,y value is x=12, y=30 and the Tolerance Control 23e value is x=0, y=0. In user design, movement of the object conveyed in Row O1 would result in application software 28 capturing the coordinates associated with the move (coordinates different from the values in Object Control 23d of x=12, y=30). Thus, in comparing the different values to the allowable Tolerance Control 23e values of zero (i.e. x=0, y=0), the user change would not be allowed. Such comparison methods of baseline value user-initiated changes to allowable tolerances can be applied in like fashion to other movements or changes to the object location such as cropping or rotation, etc. Again, it is emphasized that more a single x,y set of coordinates is used for illustrative purposes and a greater number of coordinates would be required for location-oriented control. In essence, any change to objects or to palette attributes (such as background color) can be controlled through use of tolerances as long as such changes are quantifiable in design application software 28. Referring now to Replace Control 23f, it holds a value “Prod 1” to convey that the object will be replaced in the production cycle in a specific manner. In this example the object identified in Object ID 23b (facsimile diploma certificate) will be replaced with a final diploma certificate object.

Row O2: Object Source 23a identifies the source of the object as a school supplied object. Object ID 23b identifies the object as an official seal used by the school. Object Control 23d provides the coordinates for placing the object onto the palette. In this instance the coordinate values in Object Control 23d (x4, y39) place the object to the left of object O1 (facsimile diploma certificate). Again the location is fixed by Tolerance Control 23e values (x=0, y=0). Replace Control 23f holds a value “NA” to convey that the object will not be replaced with another object (i.e. that the object O2 is not a placeholder object.

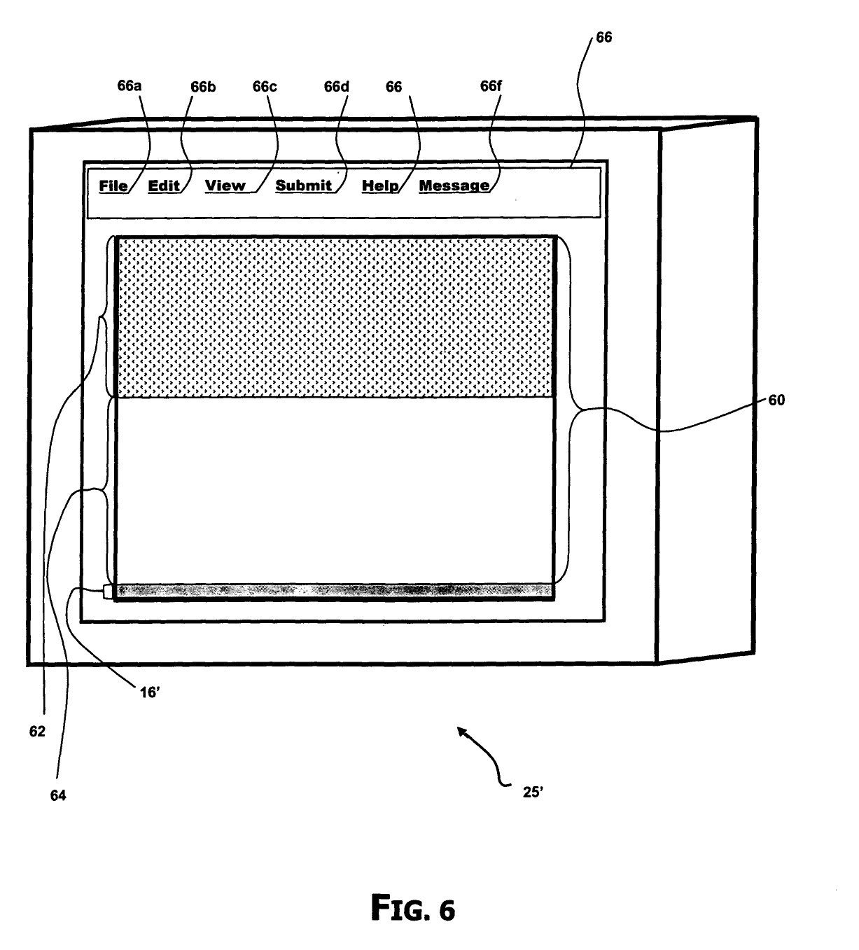

Row O3: Object Source 23a identifies the source of the object as a school supplied object from the Music Department. Object ID 23b identifies the object as a digitized photo of the marching band of which the user is a member. Object Control 23d provides the coordinates for placing the object onto the palette. In this instance the coordinate values in Object Control 23d (x6, y4) provides a baseline location; however, since Tolerance Control 23e is x=10, y=0 the object may be moved significantly along the x- axis (horizontal axis). The y value (y=0) allows no movement up and down the y-axis, and effectively keeps the object near its baseline y-axis position. Note that tolerance values could be applied to allow movement in only one direction. For example, movement in one direction would be controlled through the use of greater than (>) and/or less than (<) operators. Therefore, if the user moved the object of O3 from the baseline location (x=6) up the x-axis by two units (i.e. to x=8), the movement up could be prohibited through application of the tolerance using greater than (>) operators in verification of acceptable changes checking routine. To clarify, baseline location (6) minus change location (8) equals −2 i.e. (6−8=−2). Comparison to Tolerance Control 23e value (y=10) to the change value (−2) using the condition (change value>than 0 and change value≦10) would cause the user change to fail i.e. (−2) is not between 0 and 10. FIG. 3 further discusses validation in relation to acceptance of changes to control record 23. Referring back to O3, Replace Control 23f holds a value “NA” to convey that the object will not be replaced with another object. FIG. 6 discusses aspects of supporting the user in manipulating objects relative to baseline locations.

Row O4: Object Source 23a identifies the object source as a school supplied object, again from the Music Department. Object ID 23b identifies the object as a digitized video/audio stream of the marching band performing. Object Control 23d, Tolerance Control 23e, and Replace Control 23f all hold the value “Pending”. This reflects the fact that the school has not yet determined if such objects will be allowed in design efforts.

Row O5: Object Source 23a identifies the object as a school supplied object. Object ID 23b identifies the object as a control object designed to provide playback of a video stream object as referenced in record O4. Thus it holds the same values (“Pending”) as O4 in the fields Object Control 23d, Tolerance Control 23e, and Replace Control 23f. Allowance of the video object represented by record O4 in object approval process 20 (FIG. 2), in the present embodiment, would result in approval of the dependent control object represented by record O5 due to this dependency. This dependency might be codified in object control assignment 22 (FIG. 2) wherein the Object Control 23d value for the control object O5 is a derivative of the value assigned to video stream object O4. A derived value for O5 would force the location of the object to be in properly affiliated proximity to the object upon which it is dependent (i.e. O4). For example, if video stream (O4) object's Object Control 23d coordinates were set to x5,y5 then control object O5 might have its Object Control 23d coordinates be a function of O4 coordinates. Such a function might be to add or subtract a constant to the O4 x,y values. For example ((O5x=(O4x)−a constant)) e.g. O5x=5−4=1. The y-axis value for O5 could be derived in the same manner.

Row O6: Object Source 23a identifies the object as a third party object from a school photography vendor. Object ID 23b identifies the object as a digitized photo of the recipient during graduation ceremony. The vendor has contracted to take electronically created photographs of users in graduation attire on convocation day. However, since the design effort occurs well before graduation, the photographer will provide access to a senior photo to serve as a placeholder during design. Object Control 23d values initially place the object on the palette. Tolerance Control 23e values x=0, y=5 allow some y-axis movement by the user. In this case x=0 prohibits the object from horizontal movement. (Such control would be used to force an object to be centered on the palette in the event the initial Object Control 23d value so centered an object.) Replace Control 23f holds a value “Prod 2” to reflect the replacement procedure of the placeholder photo. In this example, the fact that the replacement occurs after design efforts means that the object would come into the production system and be replaced during production (much like the replacement of the facsimile diploma certificate in O1). This type of replacement would occur using the final x,y coordinates to place the replacement object in the final (acceptable) location of the placeholder object. Note that replacement may occur during design efforts as well, not only in production. (See discussion in FIG. 3.)

Row O7: Object Source 23a identifies the source of the object as a user supplied object. Object ID 23b identifies the object as a photo object of a school dormitory. Object Control 23d x,y values initially place the object. Tolerance Control 23e values (x=5, y=5) indicate that the object may be moved in both the horizontal (x) and vertical (y) axes. Again, these values could be used to control a range of plus or minus the value or constrain the movement in one direction. Replace Control 23f holds a value “NA” reflecting that there is no replacement to occur.

Row O8: Object Source 23a identifies the source of the object as a user supplied object. Object ID 23b identifies the object as a photo object of a dog. The remaining fields under discussion show a value of “NA”. This is due to the fact that object approval process 20 (FIG. 2) determined that the object was of a copyrighted photo of an image owned by a music company. The dog in the photo is a symbol used by the student's favorite musical group. The student is attempting to obtain copyright allowance, however the school feels this may be unlikely and that the object is of dubious value in presenting the proper image of the school. Thus in object control assignment 22 (FIG. 2) the values for Object Control 23d, Tolerance Control 23e, and Replace Control 23f were assigned “NA”, effectively removing the value from further access in design.

Row O9: Object Source 23a identifies the object source as a school supplied object. Object ID 23b identifies the object as the school mascot and it represents the school's solution to the user's desire for such an object. Object Control 23d holds values x21, y17 to provide an initial placement of the object onto the palette. Tolerance Control 23e values x=5, y=5 allows horizontal and vertical movement from its original placement location. Replace Control 23f holds a value “NA” to convey that the object is not a placeholder.

Thus, an initial layout of a set of objects is created and in like fashion, a set of acceptable changes (tolerances) are developed for further processing in design and producing the final display document 32 (FIG. 1). Note that the above example concentrated on controlling the position of an object fixed in its original (baseline) size. However, Object Control 23d values can be any quantitative measures that are capable of being recorded as changes within design application software 28. Therefore the scope of the invention includes, but is not limited to, developing baseline attributes in Object Control 23d and Tolerance Control 23e, for a wide range of object attributes. Such attributes include object resizing (making the original image larger or smaller), cropping (selecting a subset of the original image), rotation (changing the original orientation of the horizontal and vertical relationships) overlay (one object over another, etc. Color aspects would include background colors. In general any attribute for which design application software 28 can record a computer accessible code can serve in the appropriate fields of control record 23. Thus any object attribute so applied in the graphics arts could be controlled. Thus, it is to be understood that a control record 23 can contain any number of fields to establish object attributes and any number of fields to establish the range of allowable user freedom associated with changing those attributes and any number of fields required to control object replacement or other production actions. The number of such fields is constrained only by the design application software 28, database software, or computer hardware. The nature of any such additional fields within control record 23 (FIG. 1, FIG. 2) will vary depending upon the decisions made in design controls 24 (FIG. 1, FIG. 2) development process. Those practiced in graphic art computer systems are familiar with alternate methods of developing record structures, locating objects on a palette, and quantifying object attributes. The method herein is designed for clarification in exposition. The schema and descriptive nature is not intended to be limiting upon the scope of the invention. Furthermore, the software processes, indicia (fields), central repository 18, object library 26, etc. are conventionally implemented in conventionally available computer systems.

### C. Object Access, Display Design, and Design Evaluation

Note that in the discussion in FIG. 3, the interim design document created by the user is called a “display document” to distinguish it from the “final display document” 32 (FIG. 1). The final display document 32 FIG. 1 is a final document, the design of which is approved and the production authorized, by the certifying organization. FIG. 3 shows the process flow of FIG. 1 for bringing the approved objects into the design process for further manipulations to the baseline layout developed in the process and discussion of FIG. 2 and FIG. 2a, and the design controls 24 of FIG. 1 and FIG. 2.

In FIG. 3 the object library 26 of FIG. 2 has been segmented into a location for objects available 26a and a location for new and replacement objects 26b. Note that the term location represent logical locations, and not necessarily physical locations. The term “location” is a logical construct to allow for ease of exposition and a method of identifying the objects for alternate processing. Naming schema to facilitate association of the objects to location segments of object library 26 are developed by the certifying organization during development of design controls 24 (FIG. 1, FIG. 2).

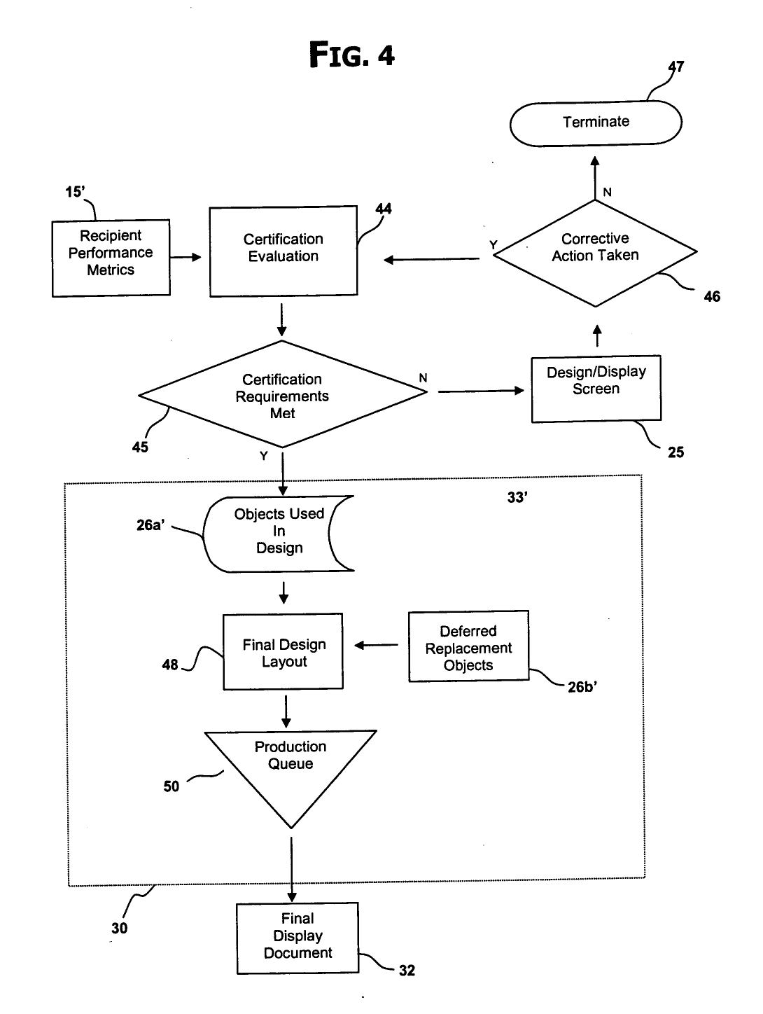

Objects available 26a holds those objects available for user viewing or manipulation during user sessions with design application software 28. New and replacement objects 26b holds new objects that come into existence following commencement of design and replacement objects that may come into existence at varying times, some for use in the user design effort, and some that are to be used in production. A location deferred replacement objects 26b′ represent those replacement objects of new and replacement objects 26b that are either restricted from user viewing, or are replacement objects that come into existence after user design efforts. In any event, deferred replacement objects 26b′ are reserved for use in the production process 30 (FIG. 1, FIG. 4).

As discussed in FIG. 2, control records 23 are associated with all objects in object library 26. Thus, for each of objects available 26a (as well as for new and replacement objects 26b), control records 23 allows initial placement onto the design palette in the fashion described below. Since the baseline values must be preserved in order to evaluate user changes, the relevant control values of an object within control records 23 (for example 23d FIG. 2, FIG. 2a), upon first being placed onto the palette, set the initial values for update records 33. While update records 33 serve as a repository for acceptable user changes to baseline values, they are initially set to baseline values to provide a starting point for the user. The structure of update records 33 is sufficiently equivalent to control records 23. Thus, while the values of update records 33 may change due to user design actions 37, Object Control 23d (FIG. 2, FIG. 2a) values of control records 23 (FIG. 2, FIG. 2a) for a given object, do not change. The values are retained for use in validation routine 41 to compare with change records 40 (which hold the proposed user changes to design objects—see discussion below). Tolerance Control 23e (FIG. 2, FIG. 2a) values of control records 23 (FIG. 2, FIG. 2a) also remain unchanged, and are used in a validation routine 41.

User (intended recipient) sign-on 34, and successful user access authorized 35 “Y”, provide access to design application software 28 and startup procedures 36 are initiated in one embodiment. Startup procedures 36 would typically include conveyance of motivational and/or educational user messages 16 (FIG. 1 and FIG. 2) to be placed on the appropriate location on the design/display screen 25. (User messages 16 (FIG. 1) positioning on the design/display screen 25 is further described later in the discussion of FIG. 6). The objects available 26a are also placed onto the design palette of design/display screen 25 according to the computer readable instructions in update records 33. Such access, in one embodiment, is a conventional Internet access to the system of the present invention.

As the user initiates design actions 37 upon the objects, design application software 28 records the changes in change records 40. The record structure of change records 40 is sufficiently equivalent to that of control records 23 to allow comparison of attribute changes. A decision query 38 is initiated when the user indicates a desire to end the session. Decision query 38 requires a response from the user to determine whether the user desires to commit the design to storage. A response to decision query 38 in the negative (“N”) by the user causes terminate session 39 to end the session and the change records 40 are not saved. A response to decision query 38 in the affirmative (“Y”) by the user initiates validation routine 41. Validation routine 41 is a group of algorithms wherein appropriate object control values in design change records 40 are compared to baseline values of Object Control 23d field(s) (FIG. 2, FIG. 2a) of control records 23. The comparison establishes the degree of change being proposed by the user. This degree of change is further compared to appropriate values of Tolerance Control 23e field(s) (FIG. 2, FIG. 2a) of control records 23. This comparison results in a determination of whether the changes in change records 40 are accepted or rejected. If validity decision 42 evaluation is negative (“N”) then terminate session 39 is invoked. If validity decision 42 evaluation is positive (“Y”) then changes are accepted and the prior values the control values of update records 33 occurs and terminate session 39 closes out the session. In an alternate embodiment, the session would not necessarily terminate upon update records 33. Rather, in such an embodiment, the user may view the result of changes at any time to determine if incremental changes are acceptable. Further, in such an embodiment, the user would continue working in design application software 28 rather than be terminated from the session.

Upon the last session of design efforts, as approved and finalized by the user, and meeting all requirements of the certifying organization, a final set of acceptable update records 33 are thus available for the production process. Thus, upon completion of design efforts, there exists a set of objects used in design 26a′, a set of deferred replacement objects 26b′, and associated controls. The control values are either baseline control record 23 values initially written into update records 33, or changes to the baseline values overwritten into update records 33. Note that objects used in design 26a′ in this embodiment may be different than the initial set of objects available 26a. This can come about when the certifying organization allows the user to remove an object from the user design palette during design actions 37.

The design system of the present invention thus described provides the basis for controls within a level of user freedom to design and create an improved display document. The motivational aspects of the system not only include user messages 16 but also the sense of involvement associated with the design process. In one embodiment, design efforts would begin well before certification in order to leverage the motivational and educational potential of the system. In an academic environment, the design effort could serve as a class project for credit toward graduation. It is the intent of the present invention, as shown in the examples above, that users engage the system many times during the design process to build on the available motivational aspects of the system. Such is the spirit of the system and methods disclosed herein. Any representation to the contrary should not be taken out of context.

### D. Post-design Process

FIG. 4 shows an embodiment of FIG. 1 in which recipient performance metrics 15′ provides data to a process of certification evaluation 44. Recipient performance metrics 15′, in this embodiment, come from representative source 12b (Source B); the same source that provides performance measures 15 (FIG. 1) in creating user messages 16 (FIG. 1). However, in certification evaluation 44, the performance metrics 15′ are specifically intended to determine if certification requirements have been met (i.e. the intended recipient is qualified for certification) and thus certification requirements condition evaluation 45 is affirmative (“Y”), then production process 30 can commence.

If certification requirements condition evaluation 45 fails (“N”), then the user is notified via design/display screen 25 that certification requirements have not been met. Such notification may include conveyance of recipient performance metrics 15′ to indicate the nature of the problem, and support remedial action. Note though that interim use of certification evaluation 44 during user design is well within the intent of providing motivational user messages 16 (FIG. 1) to the user. Since user involvement (in the embodiment of FIG. 3) of the design process is intended to occur reiteratively over a long period of time, constant feed back to the user of progress toward certification ties the design effort to actions that support certification. The messaging capabilities of design/display screen 25 provide a continuous conduit to provide interim performance feedback for an extended period during the design effort.

If necessary corrective actions are taken by the intended recipient (corrective action taken evaluation 46 is “Y”), then a re-assessment through certification evaluation 44 will result in certification requirements condition evaluation 45 in the affirmative (“Y”), and production process 30 will be initiated. Upon such approval, objects used in design 26a′ and deferred replacement objects 26b′ can be applied to create the final design layout 48 containing all of the required controls and objects sufficient to create a final display document 32 are merged into the production queue 50. Production of the final display document 32 completes the process.

In the event corrective actions are not taken, (corrective action taken evaluation 46 is negative “N”) termination process 47 is initiated which results in the user failing to be certified and the design is removed from consideration to be added to the production queue 50.

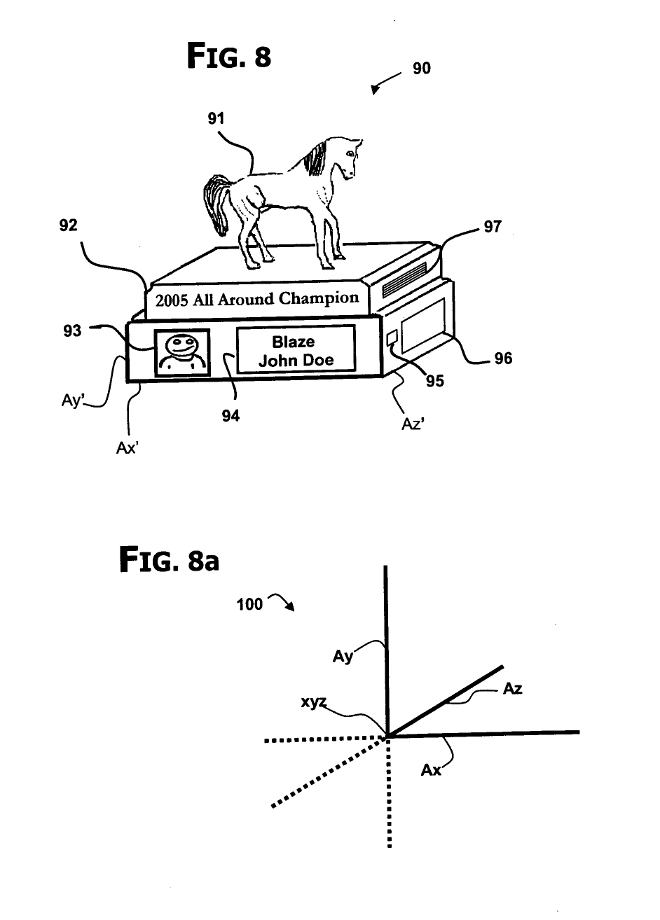

In various embodiments, final display document 32 may be hardcopy, electronic, or a hybrid document. A hybrid document would include hardcopy display along with electronic hardware means for playback of electronic objects. Electronic output enables transmission of a document over networks such as the Internet or conveyance via storage media such as floppy disks and CDs, etc. Indeed, the output could be three-dimensional such as a physical trophy or as a holographic image. Additional embodiments beyond two-dimensional hardcopy output include raised relief plaques, or embossed representations of a certificate object. FIG. 8 shows one such embodiment of a final display certification in trophy form.

### E. Centralized Database

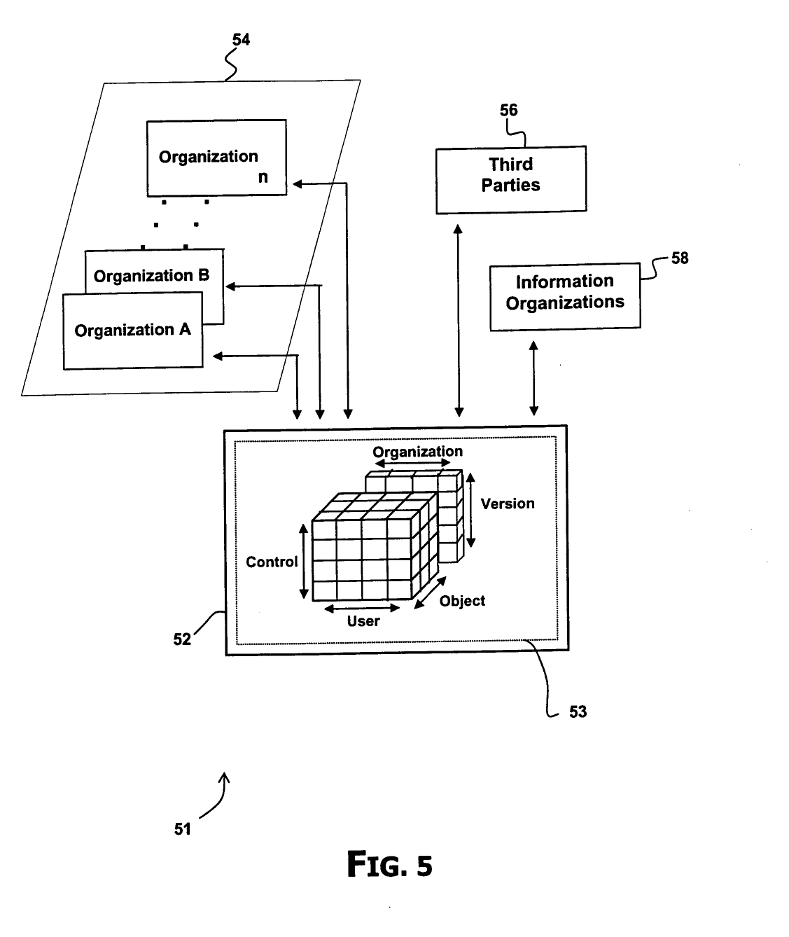

FIG. 5 shows an embodiment of the centralized system of FIG. 1. In FIG. 5, computer network 51, comprising a shared database 53 within a network server 52. A group of certifying organizations 54 is connected to network server 52 to access shared database 53 to utilize the data and objects in certificate design efforts. Additional groups representing alternate sources of data and information are also connected to network server 52. In the present embodiment, these include a group of varying numbers of third party organizations 56 such as vendors, and a group of varying number of information organizations 58 such as information sources for providing user messages 16 (FIG. 1, FIG. 2). Shared database 53 of network server 52 provides a structure for storing, accessing, and serving design application software 28 (FIG. 1, FIG. 3), objects, controls, and design versions for multiple organizations with multiple users. Shared database 53 serves as the basis for interfacing with design application software 28 (FIG. 1, FIG. 3) to provide the flexibility to meet the demands of multiple users of a centralized system.

Prior to this FIG. 5, the discussion of the system and methods focused primarily on the interactions of a single organization and to a certain degree a single user. The objects and controls previously discussed are required regardless of the number of organizations or users, however, in a small application such as a single organization and minimal users, the number of objects can be manually controllable and the design controls 24 (FIG. 1, FIG. 2) could be minimized. Acceptable design changes could be approved through visual inspection of the final display document. Clearly though, manual inspection would minimize system efficiencies, especially when large numbers of organizations and users were involved. In order to realize the greatest benefits of the system and methods herein, a configuration is needed which accommodates multiple users from multiple organizations.

There are clear benefits from centralizing multiple certifying organizations 54. Such centralization allows for sharing of objects, design techniques, templates for design layout, educational and motivational messaging and methods of conveyance for maximum effect, centralized copyright agreements, etc. However, it is clear too that each organization, just as each user, has unique needs in design and control that must be accommodated. Aside from the obvious fact that customization of a display document requires individual objects, controls must also be customized. Some organizations will allow a wide range of user decisions and freedom in design, others will require that user design efforts be confined within a pre-designed template. Thus, a flexible database structure is required to realize the unique needs. Shared database 53 shows an embodiment of a multi-dimensional database structure of five dimensions. Dimensions in this embodiment are: Organization, User, Control, Object, and Version. By utilizing such a database the unique needs of, and the sharing opportunities for, a wide range of organizations and users can be realized.

In addition, use of Open Pre-press Interface (OPI) typically takes place within a client-server architecture. The computer network 51 is consistent with utilizing the efficiencies of low-resolution objects located on clients and high-resolution objects located on network server 52. Use of OPI would add yet one more level of efficiency to the centralized system embodiment of FIG. 1.

Computer network 51 layout and the structure of a multi-dimensional shared database 53 is but one method for realizing a centralized system and additional dimensions could be added to realize alternate needs. More or less dimensions could be used, and alternate structures such as a relational model of data storage, known to those in the computer sciences, could also meet the needs of the system.

### F. Design/Display Screen Interface

FIG. 6 shows a perspective view of one embodiment of a design/display screen 25′ conveying a design palette 60, comprising a restricted palette 62, and a user palette 64. In the present embodiment, a user message window 16′ is also located on the displayable screen area. A user accessible menu 66 is shown that provides functions typical of graphical user interface (GUI) applications. A set of commands, File 66a, Edit 66b, View 66c, Submit 66d, Help 66e, and Message 66f are shown as accessible to the user. Together, design palette 60, menu 66, and user message window 16′ make up the primary displayable elements of this embodiments of design/display screen 25′. This embodiment is an example only and does not limit the invention.

While FIG. 6 shows a singular rectangular-shaped restricted palette 62, the certifying organization, as discussed earlier, is free to restrict any area of the design palette 60 through applying initial control record 23 (FIG. 2, 3) to an object to prohibit any unapproved design actions 37 (FIG. 3). The shape of both restricted palette 62 and user palette 64 are thus variable.

User message window 16′ provides an area for educational and motivational messages (15, 15a FIG. 1) to be conveyed to the user during design and other activities when the user is signed onto the system. While a small rectangle represents user message window 16′, the shape could be of any form. For example, should the certifying organization desire, design palette 60 could be made narrower and user message window 16′ wider to allow more space for user messages 16 (FIG. 1). An expanded area for user message window 16′ would allow for graphical displays such as charts, animation, or other techniques for optimum communication. In an alternate embodiment, messages could be expanded to a full screen view via the menu options. In the present embodiment, the elements of menu 66 (i.e. 66a, 66b, 66c, 66d, 66e, and 66f) and the allowable actions within the elements, are customized by the organization to reflect the level of design freedom afforded the user. However, lack of customization in menu 66 would not preclude implementation.

Recall that in the present embodiment, a user may initiate design actions 37 (FIG. 3) that are subsequently rejected by the validation routine 41 (FIG. 3). Such validation allows a fail-safe design for any design efforts that are outside of the organization's desire. However, menu 66 is provided to aid the user in working within the design controls applied by the certifying organization.

The following discussion is presented to provide a feeling for these commands within the context of the present embodiment in which a wide range of freedom may be afforded to the user.

Menu item File 66a provides the ability for new design efforts to begin; opening of existing design document versions and template layouts could be accessed from this option. In GUI applications, it is typical to provide a print option from menu item File 66a. In the present embodiment, printing is disabled. Menu item Edit 66b allows the user to selectively modify the design attributes of the objects to which the certifying organization has so allowed access. Cropping, resizing, and rotating, are some such actions, as are undoing and redoing typing actions. If allowed, existing objects could be cut from the user palette 64 as well, using menu item Edit 66b. Menu item View 66c facilitates alternate views of the design palette 60 such as through gridlines which locate and show x,y coordinates of baseline Object Control 23d (FIG. 2, FIG. 2a) and Tolerance Control 23e (FIG. 2, FIG. 2a). Such utility could allow the user to ensure easy placement of objects and to understand the nature of the controls applied. Alternate views such as page layout orientation (portrait, landscape), previewing a production layout of the design, activating a control object to view a playback of an animated video object are additional options that could be made available. Menu item View 66c would also support refreshing the screen to view interim design changes. In such an embodiment, changes could be validated to tolerances prior to committing the design to update records 33 (FIG. 3). Menu item Submit 66d provides a facility for the user to submit design actions 37 (FIG. 3). Menu item Help 66e provides typical utilities that provide assistance to the user in navigating or understanding design application software 28 (FIG. 1, FIG. 3). Menu item Message 66f can provide the utility for the user to review past communication of motivational or educational user messages 16 (FIGS. 1). In addition, two-way communication can be facilitated as well. For example, in the event the organization, through results of certification evaluation 44 (FIG. 4), determines that the user is deficient, notification to the user of the deficiency could occur through use of message window 16′. The user may respond through use of communication functionality via Menu item Message 66f.

The nature and functionality of the computer art of application software is constantly improving and evolving, and the present nature and functionality of the computer interface in the present embodiment is not intended to be limiting on the scope of the invention.

### F. Output Examples

The figures in this section refer to the objects for the example illustrated in FIG. 2a (O1, O2, O3, O4, O5, O6, O7, O8, and O9). The following discussion utilizes these and other objects to present a graphical object format of various representations of output, interim versions of display, or other embodiments of displays of certification. These figures reinforce the application of the system and methods and considerations in producing a wide range of such displays. FIG. 8 shows an example of an alternate embodiment of output from the system and methods of the invention in the form of a three-dimensional final display certification 90 (FIG. 8). Two-dimensional output and three-dimensional output utilizing a wide range of objects and a wide range of means in various media represent the output of final display certification.

FIG. 7 shows nine objects O1′, O2′, O3′, O4′, O5′, O6′, O7′, O8′, and O9′ in graphical form. Facsimile certificate O1′, and school seal O2′ were provided by the school. Band photo O3′ and band video O4′ are from the school's music department. Video control object O5′ is a control object provided by the school. Third party placeholder photo O6′, a photo of the user is a placeholder object (senior photo to be replaced by graduation ceremony photo). User-provided photos include Dorm photo O7′, and Dog photo O8′. Dorm photo O7′ was approved during object approval process 20 (FIG. 2), however, Dog photo O8′ was not. School mascot O9′ was provided by the school as a substitute to Dog photo O8′. Additional graphical objects have been added to some of the following figures to aid in exposition. The present invention is not limited to the type or nature of the object. Objects can be graphical, symbols, text, video, photos, sound, etc. In the case of objects requiring electronic operation (e.g. sound or video) it is well known how to add such operations.

FIG. 7a shows a preview of an interim display certification document 71 containing four primary objects. (Note that background color is well within the definition of an object, but it is not shown in the embodiments of output). These objects are facsimile certificate O1′, school seal O2′, third party placeholder photo O6′, and a text object 76 created by the user (text object 76 is not one of the objects shown in FIG. 2a). Recalling the discussion in FIG. 2a, the objects O1, O2, were located onto the palette via x,y coordinates using values of Object Control 23d (FIG. 2a) (as was third party photo O6); Tolerance Control 23e (FIG. 2a) values were shown to be x=0, y=0 for both of these objects (O1, O2). Thus, these two objects reside on restricted areas of the palette since validation routine 41 (FIG. 3) would reject any such movement by nature of the zero values. Third party photo O6 Tolerance Control 23e (FIG. 2a) values were x=0, y=5. Thus movement up and down by a controlled amount is allowed. Note also that objects in FIG. 2a, facsimile diploma certificate O1 and third party photo O6 show values in replace control 23f (FIG. 2a) indicating that they are placeholder objects and will be replaced in production process 30.

Returning to FIG. 7a, the user has provided a text object 76 that would have been processed through design controls 24 (FIG. 2). As was discussed, considerations in design controls 24 process include allowable movement ranges. In the case of text object 76, an example of such considerations might include ensuring that text object 76 was assigned an area confined to that area below facsimile certificate O1′ and that it could not overlay any of the other objects. The user has decided to place it in a centered fashion below the third party placeholder photo O6′.

Once the user completes the design, it will be submitted to production process 30 (FIG. 1, FIG. 4). Affirmative certification evaluation 44 (FIG. 4) will result in deferred replacement objects 26b′ to replace the placeholder objects O1′ and O6′. In this case, the output will be available only after graduation since the replacement photo for third party placeholder photo O6′ will be taken at the graduation ceremony. Depending on the system architecture, school seal O2′ may also be slated for replacement: as previously discussed, in an Offline Pre-press Interface (OPI) environment low resolution objects are used in design to minimize demands on the central server. In production, a high-resolution object utilizes the placement controls to replaces the low-resolution object.

FIG. 7b shows a final display certification document 32′ after replacement with deferred replacement objects 26b′ (FIG. 4). In this case the deferred replacement object is a final certificate 80 which has replaced facsimile certificate O1′ (FIG. 7a). An additional replacement has occurred with a third party graduation photo 78, replacing the third party placeholder photo O6′ (FIG. 7a). Recall In the discussion of FIG. 7a above, the user, in this embodiment, had controlled freedom to place third party photo O6′ (FIG. 7a) along the y-axis, but was restricted from movement along the x-axis. In replacement, the final coordinates established by the users actions along the y-axis of third party placeholder photo O6′ (FIG. 7a) were used in to place graduation photo 78. These coordinates would have been either baseline Object Control 23d (FIG. 2 FIG. 2a) values or values from update records 33 (FIG. 3) based upon user determination and consistency with organizational controls in Tolerance Control 23e (FIG. 2, FIG. 2a). Note that the user has arranged dorm photo O7′, school mascot O9′ and marching band photo O3′ as well. In the same manner of placement as the third party placeholder photo O6′ (FIG. 7a), the ranges of allowable movement were established during design controls 24 (FIG. 1, FIG. 2) process by the certifying organization setting Tolerance Control 23e (FIG. 2, FIG. 2a). These controls are applied in validation routine 41 (FIG. 3). By utilizing the initial placement set in Object Control 23d in conjunction with Tolerance Controls 23e (FIG. 2, FIG. 2a) a range of movement for objects is established. The dotted lines 78xy, O3′xy, O7′xy, and O9′xy in FIG. 7a indicate a loose approximation of allowable ranges, in this example, of user design movement of said objects based upon the design freedom conveyed in Tolerance Control 23e (FIG. 2, FIG. 2a) values. This example illustrates the functional ability of the present invention to provide a certificate wherein a user can place at least one object in a designated area (e.g. 78xy). While this example uses a two-dimensional x,y coordinate system to create certification output such as final display certification document 32′, as mentioned above, three-dimensional certification documents, design objects, and associated controls are well within the scope of the invention.

FIG. 7c shows an electronic version of a two-dimensional final display certification document 32a′. This instance utilizes animated band video O4′ of the band marching and playing. Note also the addition of the dependent video control object O5′ used for controlling playback of band video O4′. Note also two diploma certificates are shown. In this embodiment, a higher order certificate 82 has been added in addition to final certificate 80 (initially shown as a replacement object on FIG. 7b). Note that final certificate 80 and the higher order certificate 82 need not be from the same organization: In a system embodiment such as the one portrayed in FIG. 5, a shared database 53 (FIG. 5) provides for sharing of objects across organizations and time.

An electronic version of final display certification document 32a′ provides the utility for suitable for playback of the animated video/audio stream O4′ utilizing conventional hardware. Such hardware includes a final display document 32a′ stored on a compact disc (CD) to be played on a portable CD player. In an alternate embodiment, the electronic version and the hardcopy version could be melded through a combination of electronic conversion devices. In this alternate embodiment, such devices would include video and/or audio conversion hardware, along with a framework that encased the devices in a manner such that the final display could be viewed in a physical form consistent with electronic playback of the audio and video objects. FIG. 8 shows an alternate embodiment of a final display certification 90 employing such means.

FIG. 7d shows a final display certification document 32b′. The intended recipient (user) has provided an additional alternate personal object embodiment in the form of a fingerprint object 84′ along with a graduation photo object 78′ both of which are printed or otherwise affixed on special paper 84. While the school has determined that all objects are fixed, the user has an option of photograph versions (a senior photo or a graduation photo). Fingerprint object 84′, photo object 78′, and special paper 84 are intended to further diminish counterfeiting through use of personalized objects in conjunction with tamper proof means. In an alternate embodiment, the special paper 84 utilized for photo object 78′ and fingerprint object 84′ could be of special paper such as that used on bank drafts or in another embodiment, holographic media to further diminish counterfeiting. Other embodiments to diminish counterfeiting in combination or substitute for fingerprint object 84′ include objects of the recipient's voice prints, in an electronic version, an electronic voice print, or other electronically reproducible identifiers that may come available, could be used.

Note that regardless of the use of control objects for playback of electronic objects, all documents represented in the figures discussed above (71, 32′, 32a′, 32b′) above could be stored on storage media such as floppy disks, CD's or transmitted over the internet for viewing.

While the above figures illustrate primarily a two-dimensional final display certification 90 (FIG. 8), the present invention also provides three-dimensional final display certification 90 such as trophies or plaques.

FIG. 8 shows an alternate embodiment of a final display certification 90 in the form of a trophy representing a physical three-dimensional horse object 91. The trophy is further personalized by the horse owner's own digital image 93, along with personalized text object 94 of the owner's name and horse's name. Final display certification 90 as shown in this embodiment also includes a video display device 96, an audio speaker 97, and video and audio control device 95. In a three-dimensional embodiment, additional design considerations are associated with design controls 24 (FIG. 2) in the form of design attributes and controls using an additional dimension along a third axis (z-axis).

FIG. 8a shows each of the three axes of a three-dimensional coordinate system 100. Axis Ax represents the x-axis and axis Ay represents the y-axis of two-dimensional design coordinate system associated with two-dimensional final display certification 90 output such as 32b′ (FIG. 7d). Axis Az shows the third axis of a three-dimensional design coordinate system. The intersection of axes Ax, Ay,Az is shown on FIG. 8a to identify the point xyz where x=0, y=0, z=0.

Referring again to FIG. 8, note that the positional reference to the three-dimensional axes of FIG. 8a are shown in FIG. 8 as reference Ax′, reference Ay′, and reference Az′. Thus, placement and control considerations would utilize three coordinates. Thus the third coordinate would be included in the processes represented in design controls 24 (FIG. 2) and user design-change evaluation in the processes of FIG. 3. Including the development of Object Control 23d (FIG. 2, FIG. 2a) values in x,y,z coordinates, and associated x,y,z Tolerance Control 23e (FIG. 2, FIG. 2a) values to control user design changes in a three-dimensional design environment.

The user, in developing the final display certification 90, has significant freedom when developing the display objects including text, video, and audio, subject to the design controls 24 (FIG. 1, FIG. 2). Note also that three dimensional horse object 91 could be created through digitally supported manufacturing processes wherein two dimensional digitized objects (such as digital photographs taken by the user) are converted into three dimensional objects of various media, including plastic. With the availability of holographic generators, a three-dimensional horse object 91 could, in another embodiment, be produced as a holographic image.

Video display device 96 allows for video playback of events such as the user's recording of the performance of the horse that secured the certification of champion. Audio speaker 97 further enhances the display value by adding playback attributes of recorded audio sounds associated with a trophy embodiment of final display certification 90.

Three-dimensional representations such as trophies provide an enhancement to the sentimental value of display through a heightened portrayal of realism and personalized memories wherein the user can place objects into a design.

In another embodiment, raised or embossed plaques provide alternate presentation attributes in three dimensions.

In regard to the teachings herein, many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A method for producing a certificate for a certifying organization unique to a user, said method comprising:
providing a plurality of certificate objects unique to the certifying organization,
providing a plurality of personal objects unique to the user,
approving objects from the plurality of (1) certificate objects and (2) personal objects for storage in an object library database,
assigning each of the approved objects a data record, the data record at least having a field identifying the location of the object on the certificate and a field identifying the object,
providing a plurality of messages,
displaying the certificate on a screen, the displayed certificate having each approved object visually located on the displayed certificate,
displaying selected messages from the plurality of messages with the displayed certificate on the screen,
validating the certificate based on comparison of location field value and tolerance value,
producing the certificate in response to the step of validating.

2. The method of claim 1 wherein the data record further includes a field for identifying the source of the approved object

3. The method of claim 1 wherein the data record further includes a field for identifying the individual corresponding to the approved object.

4. The method of claim 1 wherein the data record further includes a field for update requirements.

5. The method of claim 1 wherein said plurality of certificate objects include a facsimile certificate.

6. The method of claim 1 wherein the data record further includes a field for validation.

7. The method of claim 1 further comprising:
authorizing access to the user to validate the certificate.

8. The method of claim 7 wherein authorizing further comprises:
permitting the user to change approved personal objects on the displayed certificate.
